(19) United States
(12) Patent Application Publication
(10) Pub. No.: US 2018/0234715 A1
(43) Pub. Date: Aug. 16, 2018

(54) PERSONALIZED IDENTIFICATION OF ITEMS OF MEDIA CONTENT FROM ACROSS MULTIPLE CONTENT-PROVIDING ENTITIES

(71) Applicant: Caavo Inc, Milpitas, CA (US)

(72) Inventors: Ashish D. Aggarwal, Stevenson Ranch, CA (US); Andrew E. Einaudi, San Francisco, CA (US)

(21) Appl. No.: 15/892,188

(22) Filed: Feb. 8, 2018

Related U.S. Application Data
(60) Provisional application No. 62/457,240, filed on Feb. 10, 2017.

(51) Int. Cl. H04N 21/25; H04N 21/466; H04N 21/442

(52) U.S. Cl. CPC H04N 21/251; H04N 21/44204; H04N 21/44222; H04N 21/4668

(57) ABSTRACT

Systems and methods are described for identifying items of media content from across multiple content-providing entities for playback or recommendation to a user. In accordance with embodiments, a user of a media content delivery device is identified and a usage profile corresponding to the user is obtained. The usage profile identifies, for each of a plurality of content-providing entities, one or more items of media content that have been obtained from the content-providing entity and watched by the user. An unwatched item of media content may then be identified based on the usage profile and information about the unwatched item of media content may be provided to the device for presentation to the user. Alternatively, an item of media content identified in the usage profile may be played back to the user or a means for playing back the item of media content may be provided via the device.

### CROSS-REFERENCE TO RELATED APPLICATIONS

This application claims priority to U.S. Provisional Patent Application No. 62/457,240, filed Feb. 10, 2017 and entitled “Personalizing Search for Television,” the entirety of which is incorporated by reference herein.

### BACKGROUND

### Technical Field

The subject matter described herein relates to systems and methods for identifying items of media content from across multiple content-providing entities for playback or recommendation to a user.

### Description of Related Art

Different people in a single household may watch different media content originating from the same or different content-providing entities (e.g., Over-the-Top (OTT) content providers, cable/satellite television service providers, digital video recorders (DVRs), or the like). Each person may wish to find their media content quickly and even resume watching an item of media content exactly where they left off. To address this issue, some content-providing entities such as Netflix® and Hulu® enable the use of multiple user profiles for a single account so that a unique viewing history can be maintained for each user within a given household. However, not all content-providing entities support the use of multiple user profiles per account and those that do are by necessity limited to a viewing history that only takes into account media content obtained from that single content-providing entity (i.e., Netflix® cannot track what a user has watched on Hulu®, cable TV, or their DVR). Accordingly, any media content recommendations and delivery based on a viewing history are limited to a viewing history associated with a single content-providing entity.

Some conventional “meta” search providers exist (e.g., Apple TV® and Roku®) that are capable of searching for media content across multiple disparate content-providing entities. However, such meta search providers are incapable of taking into account what a user has watched across multiple different content-providing entities when performing a search. Moreover, such meta search providers are not capable of automatically finding an item of media content that a user has been watching or resume playback from a point at which the user stopped watching such item of media content.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems and methods are provided for identifying items of media content from across multiple content-providing entities for playback or recommendation to a user. In accordance with embodiments, a user of a media content delivery device is identified and a usage profile corresponding to the identified user is obtained. The usage profile identifies, for each of a plurality of different content-providing entities, one or more items of media content that have been obtained from the content-providing entity and watched by the user. An unwatched item of media content may then be identified based on one or more items of media content identified in the usage profile and information about the unwatched item of media content may be provided to the media content delivery device for presentation to the user. Alternatively, an item of media content identified in the usage profile may be played back to the user via the media content delivery device or the user may be provided with a means for playing back the item of media content identified in the usage profile via the media content delivery device.

Further features and advantages, as well as the structure and operation of various examples, are described in detail below with reference to the accompanying drawings. It is noted that the ideas and techniques are not limited to the specific examples described herein. Such examples are presented herein for illustrative purposes only. Additional examples will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a block diagram of an example system for providing personalized media content recommendations and/or delivery, in accordance with an embodiment.

FIG. 2 depicts a flowchart of a method for providing personalized media content recommendations and/or delivery, in accordance with an embodiment.

FIG. 3 depicts a flowchart of a method for playing back an item of media content, in accordance with an embodiment.

FIG. 4 depicts a flowchart of a method for resuming playback of an item of media content, in accordance with an embodiment.

FIG. 5 depicts a flowchart of a method for identifying an unwatched item of media content, in accordance with an embodiment.

FIG. 6 depicts a flowchart of another method for identifying an unwatched item of media content, in accordance with an embodiment.

FIG. 7 depicts a flowchart of another method for identifying an unwatched item of media content, in accordance with an embodiment.

FIG. 8 depicts a flowchart of a method for building a usage profile for a user, in accordance with an embodiment.

FIG. 9 is a block diagram of an example processor-based system that may be used to implement various embodiments described herein.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

### II. Example Embodiments

The example embodiments described herein are provided for illustrative purposes, and are not limiting. The examples described herein may be adapted to any type of personalized media content recommendation or playback system. Further structural and operational embodiments, including modifications/alterations, will become apparent to persons skilled in the relevant art(s) from the teachings herein.

As noted in the Background Section, above, different people in a single household may watch different media content originating from the same or different content-providing entities (e.g., OTT content providers, cable/satellite television service providers, DVRs, or the like). Each person may wish to find their media content quickly and even resume watching an item of media content exactly where they left off. While some content-providing entities such as Netflix® and Hulu® enable the user of multiple user profiles for a single account so that a unique viewing history can be maintained for each user within a given household, these user profiles are limited to a single content-providing entity only and are not useful across multiple content-providing entities used in a household (e.g., many OTT services, cable/satellite television services and personal DVRs do not track viewing history across multiple user profiles in a single household). Accordingly, any media content recommendations and delivery based on a viewing history are limited to a viewing history associated with a single content-providing entity.

Furthermore, while some conventional “meta” search providers do exist (e.g., Apple TV® and Roku®) that can search for media content across multiple disparate content-providing entities, such meta search providers are incapable of taking into account what a user has watched across multiple different content-providing entities when performing a search. Moreover, such meta search providers are not capable of automatically finding an item of media content that a user has been watching or resume playback from a point at which the user stopped watching such item of media content.

Embodiments described herein address these and other issues related to obtaining personalized recommendations and/or playback of items of media content. For instance, embodiments described herein enable personalized recommendations and/or playback of items of media content to be obtained for each user in a household based on each user's viewing history across multiple content-providing entities, including those that do not enable the use of user profiles. Furthermore, embodiments described herein enable playback of an item of media content to be resumed at the point at which the user previously stopped watching the item of media content, even if the item of content was first watched using a first content-providing entity but now is going to be watched using a second content-providing entity that is different from the first content-providing entity. Still further, embodiments described herein utilize information about items of media content watched by a user across multiple content-providing entities when identifying items of media content for search, recommendation or playback purposes.

Embodiments described herein are directed to enabling a personalized identification of items of media content for a user across multiple content-providing entities. More specifically, embodiments described herein are directed to the creation and maintenance of usage profiles to facilitate producing personalized media content recommendations and/or providing personalized media content delivery (i.e., playing back or providing a user with a means for playing back a watched or partially-watched item of media content). In embodiments, a separate usage profile is created for each user in a household that may have multiple users. For instance, a user may interact with a user interface of a media content delivery device to create a usage profile. Such usage profile may be stored in a database of a personalized media content recommendation and delivery system.

In an embodiment, a single usage profile may contain information about programs watched using multiple different content-providing entities. For instance, during a usage profile creation process, a user may identify each content-providing entity that they will use to obtain and consume media content. As used herein, the term “content-providing entity” broadly refers to any provider of media content, including but by no means limited to, a media content recording device that stores items of media content in memory for playback (e.g., a DVR), an OTT media content providing service (e.g., Netflix®, Hulu®, Amazon®), an online digital media store (e.g., iTunes®), a cable television service provider (e.g., Comcast®, FIOS®), a satellite television service provider (e.g., DirectTV®), or an audio content provider (e.g., Spotify®). Each content-providing entity included in a usage profile may or may not enable the use of user profiles.

In an embodiment, when a user adds a particular content-providing entity to their usage profile, the user may also input their login information for that content-providing entity. Such login information may include, for example, an account ID, a password, and a user profile identifier. The user profile identifier may comprise a user profile name. In embodiments, a user's user profile name may vary from content-providing entity to content-providing entity. For example, the same user may have a different user profile name (e.g., “Mom”, “Elizabeth”, and “Beth”) for each of the content-providing entities Netflix®, Hulu® and Amazon®. Accordingly, the user may add the content-providing entities Netflix®, Hulu® and Amazon® to their usage profile, and also input corresponding login information that includes their specific user profile identifier for each of Netflix®, Hulu® and Amazon®.

In an embodiment, when a user adds a content-providing entity to their usage profile that does not enable the use of user profiles, the user simply adds the content-providing entity to the usage profile and any login information (e.g., account ID and password) if necessary. For example, a user may have a household login for content-providing entities HBOGO® and FIOS®. Accordingly, the user may add the content-providing entities HBOGO® and FIOS® to their usage profile, and also input the household login (e.g., account ID and password) for each of HBOGO® and FIOS®.

In embodiments, the user may assist in generating one or more biometric identifiers for inclusion in the usage profile. For example, the user may assist in generating one or more biometric identifiers as part of a biometric training process during set-up. These biometric identifiers may include, for example and without limitation, voice samples, fingerprints, or facial images of the user. However, these examples are not intended to be limiting and any type of biometric identifier may be used. In an embodiment, these biometric identifiers may be stored in association with the user and/or usage profile in various locations. For instance, the biometric identifiers may be stored by a media content delivery device, a remote-control device that interfaces with the media content delivery device, a personalized media content recommendation and delivery system, or a combination thereof. In an embodiment, and as discussed in detail hereinafter, the stored biometric identifiers may be used by either the personalized media content recommendation and delivery system, the media content delivery device, or the remote-control device to identify the user.

Various types of remote control devices may be used in embodiments, including handheld remote controls (e.g., TV remote controls, universal remotes, etc.), smart phones, tablet devices, and further types of mobile/handheld (or immobile) devices. In an embodiment, the remote control device interfaces with a content-viewing device, for example a television, via a media content delivery device. In an embodiment, the media content delivery device includes a switch. The switch (e.g., an HDMI switch) may connect various content-providing entities to the content-viewing device.

Once a usage profile is created by a user, the personalized media content recommendation and delivery system adds information to the usage profile based on observing which items of media content have been obtained from the content-providing entities identified in the usage profile and watched by the user. In embodiments, this building of the usage profile is performed by usage profile building logic of the personalized media content recommendation and delivery system. In an embodiment, the usage profile building logic identifies an item of media content watched by the user and stores an identifier of the watched item of media content in the corresponding usage profile. This identifying may be accomplished by the usage profile building logic in various ways.

For instance, the usage profile building logic may interact with one of the content-providing entities via an application programming interface (API) to identify items of media content that have been watched by the user. Furthermore, the usage profile building logic may automatically interact with a website provided by one of the content-providing entities using the user login information included in the usage profile to identify items of media content that have been watched by the user. In embodiments, the user login information may include a user profile identifier as noted above, to ensure that the correct user information is accessed. Still further, the usage profile building logic may receive from the media content delivery device an identifier of the item of media content that was watched by the user. The media content delivery device may obtain the identifier based on user input that identifies the item of media content that was watched by the user, by analyzing media content that is being passed to a content-viewing device using automatic content recognition (ACR), or in some other manner. As such, the identified items of media content watched by the user are stored in the usage profile such that the usage profile identifies the items of media content watched by the user across multiple content-providing entities (including content-providing entities that do not enable the use of user profiles).

Once a usage profile has been created and built for a user, the personalized media content recommendation and delivery system enables personalized identification of items of media content for the user across the different content-providing entities. In an embodiment, to enable such personalized identification of items of media content, a user that is currently trying to watch content on a content-viewing device or otherwise use the media content delivery device is identified. For instance, user identification logic may identify the user. As noted above, the user identification logic may exist in the personalized media content recommendation and delivery system, in the media content delivery device, in the remote-control device, or a combination thereof. The user identification logic may make this identification in various ways.

In an embodiment, to identify the user, the user identification logic prompts the user to select a usage profile stored in the system. In an alternative or additional embodiment, the user identification logic uses another form of user recognition, such as a biometric-based user recognition. For instance, a biometric identifier may be obtained by a remote control device or the media content delivery device itself, each of which may have one or more of voice, camera, and fingerprint sensors. Once a biometric identifier is obtained, the user identification logic of the personalized media content recommendation and delivery system, the media content delivery device, or the remote control device may compare the obtained biometric identifier to the stored biometric identifiers to identify the user. Thus, in accordance with one example scenario, when a particular user picks up a remote control and touches his finger to a fingerprint sensor thereof, speaks, or has his facial image captured thereby, the user is uniquely identified.

Once a user is identified, the personalized media content recommendation and delivery system obtains a usage profile that corresponds to the identified user. For instance, usage profile access logic of the personalized media content recommendation and delivery system may obtain a usage profile that corresponds to the identified user from a database of usage profiles. Once the usage profile is obtained, the personalized media content recommendation and delivery system may use information included in the usage profile to perform actions such as identifying unwatched items of media content for recommendation or search purposes or identifying items of media content in the usage profile (e.g., watched items of media content) that the user may wish to resume watching.

In an embodiment, the personalized media content recommendation and delivery system identifies and provides information about unwatched items of media content to the media content delivery device for presentation to the user. For instance, the personalized media content recommendation and delivery system may include media content recommendation logic that identifies an unwatched item of media content based on items of media content identified in the usage profile. Furthermore, the media content recommendation logic may further provide information about the unwatched item of media content to the media content delivery device for presentation to the user associated with the usage profile. The media content recommendation logic may identify unwatched items of media content in various ways.

For instance, and in an embodiment, the media content recommendation logic identifies the unwatched item of media content by searching a database of items of media content utilizing at least one search term associated with the one or more items of media content identified in the usage profile. In another embodiment, the media content recommendation logic identifies the unwatched item of media content by searching a database of media content to obtain a set of unwatched items of media content and by filtering or ranking the unwatched items of media content in the set based on information included in the usage profile. In yet another embodiment, the media content recommendation logic identifies the unwatched item of media content by identifying an unwatched item of media content available from a first content-providing entity based on an item of media content that is associated with a second content-providing entity in the usage profile. In any of the above-described methods, and as noted above, once unwatched items of media content are identified, the media content recommendation logic may provide information about the unwatched item of media content to the media content delivery device for presentation to the user.

As noted above, in an embodiment, the media content recommendation logic filters or ranks unwatched items of media content in a set thereof. The media content recommendation logic may perform this filtering or ranking in various ways. For instance, in an embodiment, the unwatched items of media content are filtered or ranked based on whether the user possesses a subscription to a content-providing entity associated with each item of unwatched media content as specified by the usage profile. In another embodiment, the unwatched items of media content are filtered or ranked based on a cost associated with each unwatched item of media content in the set. In yet another embodiment, the unwatched items of media content are filtered or ranked based on a viewing history of the user as specified by the usage profile. In still another embodiment, the unwatched items of media content are filtered or ranked based on user preferences of the user as specified in the usage profile. In yet another embodiment, the unwatched items of media content are filtered or ranked based on an appropriateness for the user of each unwatched item of media content in the set. Furthermore, the unwatched items of media content may be filtered or ranked based on or a combination of any of the methods described above. It should further be noted that while unwatched items of media content may be provided to the user, some of the items of media content may be rendered unplayable based on the usage profile. For instance, if a usage profile indicates that a user only watches content that has a particular rating(s) (e.g., “G” or “PG”), and an item of media content is returned that has a more mature rating (e.g., “R”), then that item of media content may be rendered unplayable by the user.

Alternatively, in embodiments, the personalized media content recommendation and delivery system identifies items of media content in the usage profile and enables the playback, or provides the user with a means for playback, of the identified items of media content by the media content delivery device. For instance, in an embodiment, the personalized media content recommendation system includes media content delivery logic that identifies an item of media content in the usage profile. Once the item of media content is identified in the usage profile, the media content delivery logic either plays back the item of media content or provides the user with a means for playing back the item of media content.

For instance, in an embodiment, the media content delivery logic resumes playback of the item of media content at the point at which the user previously stopped watching the item of media content. Such point at which the user previously stopped watching the item of media content may be determined based on information included in the usage profile. Furthermore, such resumed playback may occur automatically or in response to some user input. In an embodiment, playback of the item of media content is resumed from the content-providing entity with which the item of media content is associated in the usage profile. In an embodiment, the playback of the item of media content is resumed from a different content-providing entity than a content-providing entity with which the item of media content is associated in the usage profile.

Furthermore, the media content delivery logic may provide the user with a means for playing back the item of media content identified in the usage profile via the media content delivery device. For instance, the media content delivery logic may cause the media content delivery device to display a link or other interactive control in a graphical user interface (GUI) that is rendered to a content-viewing device (e.g., TV) that is communicatively connected to the media content delivery device. When the user interacts with the control, playback of the item of media content may be resumed, e.g., from a point at which the user previously stopped watching the item of media content.

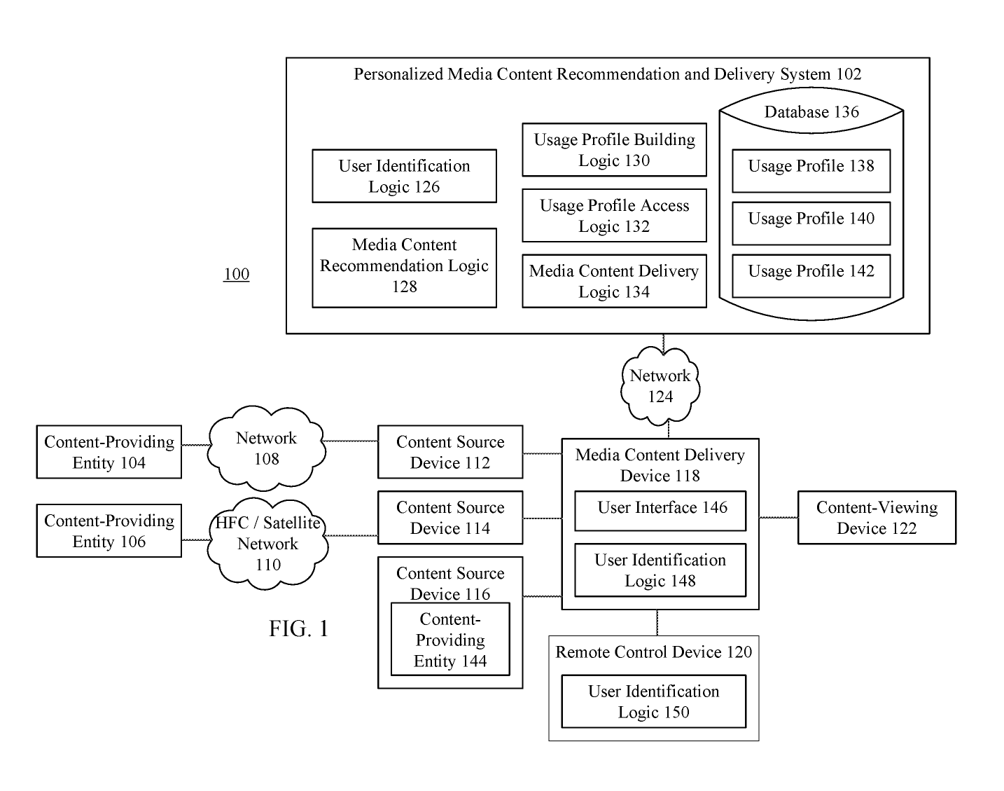

Example embodiments are described as follows that are directed to providing personalized media content recommendations and/or delivery. For instance, FIG. 1 is a block diagram of an example system 100 for providing personalized media content recommendations and/or delivery, in accordance with an embodiment. As shown in FIG. 1, system 100 includes a personalized media content recommendation and delivery system 102, a content-providing entity 104, a content-providing entity 106, a content-providing entity 144, a content source device 112, a content source device 114, a content source device 116, a media content delivery device 118, a remote control device 120, and a content-viewing device 122. It should be noted that there can be any number of content source devices and content-providing entities present in system 100.

Media content delivery device 118 and personalized media content recommendation and delivery system 102 are communicatively coupled to each other via network 124. Content source device 112 is communicatively coupled to content-providing entity 104 via network 108. Network 108 and network 124 may be the same or different networks. Network 108 and network 124 may each comprise one or more networks such as local area networks (LANs), wide area networks (WANs), enterprise networks, the Internet, etc., and may include one or more of wired and/or wireless communication links.

Content source device 112, content source device 114, and content source device 116 are communicatively coupled to media content delivery device 118. Such coupling may be wired, wireless, or a combination thereof and may be, for example, over network 124. In one embodiment, each of content source device 112, content source device 114 and content source device 116 is connected to media content delivery device 118 via a corresponding HDMI cable. Content source device 114 is communicatively coupled to content-providing entity 106 via a Hybrid fiber-coaxial (HFC) or Satellite Network 110. HFC/Satellite Network 110 enables broadcast television programs to be transmitted from a corresponding cable system headend or a communications satellite to content source device 114 (e.g., a cable or satellite set top box).

Media content delivery device 118 is configured to enable a user to watch items of media content on content-viewing device 122 and is connected thereto via a wired and/or wireless connection. In one embodiment, media content delivery device 118 is connected to content-viewing device 122 via an HDMI cable. Content-viewing device 122 may comprise a television or any other system or device rendering visual images and sound for consumption by a user.

In an embodiment, a user may interact with media content delivery device 118 via a remote control device 120. Alternatively, a user may interact with media content delivery device 118 directly (e.g., via a user interface of media content delivery device 118). Remote control device 120 may be coupled to media content delivery device 118. Such coupling may be wired, wireless (e.g., infrared, serial, WiFi, Bluetooth, etc.), or a combination thereof and may be, for example, over network 124. Remote control device 120 is intended to represent any remote that enables users to interact with media content delivery device 118 and may include handheld devices as well as stationary devices. Examples of handheld devices include television remote controls, universal remotes, smart phones, tablet devices, and other devices that can be held in a person's hand or hands. Examples of stationary devices include devices too large to be easily carried by a human, and that are intended to operate in a stationary location.

In an embodiment, media content delivery device 118 comprises an HDMI switching device such as that described in commonly-owned U.S. patent application Ser. No. 14/945,125, filed Nov. 18, 2015, and entitled “Automatic Identification and Mapping of Consumer Electronic Devices to Ports on an HDMI Switch”, the entirety of which is incorporated by reference herein. In accordance with such an embodiment, the HDMI switching device is capable of selectively connecting any one of multiple HDMI source devices (e.g., content source device 112, content source device 114, content source device 116) to an HDMI content sink (e.g., content-viewing device 122) so that HDMI content can be delivered from the connected HDMI source to the HDMI content sink and viewed thereon. Media content delivery device 118 is further connected to personalized media content recommendation and delivery system 102 (which may be implemented remotely with respect to media content delivery device 118) via network 124 which in one embodiment comprises the Internet. Media content delivery device 118 may render a GUI to content-viewing device 122 to enable user control thereof and interaction therewith. Such GUI may enable a user to interact with media content delivery device 118 and personalized media content recommendation and delivery system 102 which is connected thereto.

Media content delivery device 118 is further configured to enable a user to create a usage profile. For example, and as shown in FIG. 1, media content delivery device 118 includes a user interface 146. User interface 146 is configured to enable a user to create a usage profile, which may identify one or more content-providing entities. In an embodiment, media content delivery device 118 may cause user interface 146 to be displayed on content-viewing device 122 where it may be interacted with by the user, for instance, using remote control device 120. Alternatively, a user may interact with user interface 146 directly via media content delivery device 118. However, these are only examples and are not intended to be limiting. Moreover, the establishment of a usage profile may be carried out via devices other than media content delivery device 118 in certain embodiments (e.g., an application may be accessed via a smart phone, PC, or the like to set up a usage profile).

Each of content-providing entities 104, 106 and 144 is capable of being identified by a usage profile, as defined by the user via user interface 146. As noted above, each content-providing entity may or may not enable the use of user profiles. If a user adds a content-providing entity that enables the use of a user profile to their usage profile, the user must add the content-providing entity, the login information and the user profile identifier. Alternatively, if a user adds a content-providing entity that does not enable the use of a user profile, the user merely needs to add the content-providing entity and login information, if applicable.

As shown in FIG. 1, content-providing entity 104 is an entity capable of providing media content to media content delivery device 118. Content source device 112 is configured as a communication interface to content-providing entity 104. Content-providing entity 104 is configured to communicate with media content delivery device 118 over network 108 and through content source device 112. Content-providing entity 104 may include an OTT media content providing service (e.g., Netflix®, Hulu®, Amazon®), an online digital media store (e.g., iTunes®), or an audio content provider (e.g., Spotify®). Content source device 112 may be any device capable of providing such OTT media content to media content delivery device 118 (e.g., a Roku® streaming media player, an Amazon Fire® TV Stick, an Apple® TV, a Google Chromecast® digital media player, a gaming console, etc.). For example, if content-providing entity 104 corresponds to the Netflix® service or application and a user Mark has a user profile “Mark” for Netflix®, then Mark would add content-providing entity 104 to the usage profile, via user interface 146, and also input both login information (e.g., account ID and password) and a user profile identifier (i.e., “Mark”).

Content-providing entity 106 is a content-providing entity capable of providing media content to media content delivery device 118. Content source device 114 is configured as a communication interface to content-providing entity 106. As shown in FIG. 1, content-providing entity 106 is configured to communicate with media content delivery device 118 over HFC/Satellite Network 110 and through content source device 114. Content-providing entity 106 may include a cable television service provider (e.g., Comcast®, FIOS®) or a broadcast television service provider (e.g., DirectTV®). Content source device 114 may comprise, for example, a cable or satellite set top box or other suitable endpoint for delivering cable or satellite television content. As such, if content-providing entity 106 corresponds to the Verizon FIOS® service which has no user profiles but only a single login to the account, then Mark would add content-providing entity 106 to the usage profile, via user interface 146, and also input login information (e.g., account ID and password) for the FIOS® account.

Content-providing entity 144 is a content-providing entity capable of providing media content directly to media content delivery device 118. As shown in FIG. 1, content-providing entity 144 is configured to communicate directly with media content delivery device 118. Content-providing entity 144 may include a media content recording device (e.g., DVR) that stores items of media content in memory for playback. As such, if content-providing entity 144 corresponds to a DVR which has no profile or login, then Mark would merely add content-providing entity 106 to the usage profile, via user interface 146. Accordingly, following the example described above, user Mark's usage profile would correspond to user profile “Mark” at Netflix®, the household FIOS® account, and the household DVR. The usage profile may be stored and built in personalized media content recommendation and delivery system 102, discussed in detail hereinafter.

As shown in FIG. 1, personalized media content recommendation and delivery system 102 includes user identification logic 126, media content recommendation logic 128, usage profile building logic 130, usage profile access logic 132, media content delivery logic 134, and a database 136. Database 136 stores usage profile 138, usage profile 140, and usage profile 142. One or more of these components of personalized media content recommendation and delivery system 102 may be implemented on the same device. Alternatively, each of these components of personalized media content recommendation and delivery system 102 may be implemented on its own device. Furthermore, each of these components of personalized media content recommendation and delivery system 102 may be implemented in hardware (e.g., as digital and/or analog circuits), as software (e.g., as computer programs executed by one or more processors), or as a combination of hardware and software. Personalized media content recommendation and delivery system 102 is configured to build and store usage profiles to facilitate the personalized identification of items of media content for search, recommendation and playback.

As noted above, such usage profiles may be stored in a database of personalized media content recommendation and delivery system 102. For instance, and as shown in FIG. 1, database 136 is configured to store usage profiles for multiple users (e.g., each member of a family) that share the same content-providing entities, such as content-providing entity 104, content-providing entity 106, and content-providing entity 144, and/or content-viewing device 122. For instance, database 136 may store usage profile 138, usage profile 140, and usage profile 142. As such, in a family of three people, the first person may correspond to usage profile 138, the second person may correspond to usage profile 140, and the third person may correspond to usage profile 142. It is noted that any number of usage profiles can be created and stored in database 136 and that personalized media content recommendation and delivery system 102 may store usage profiles for any number of users across any number of households.

Note that in the foregoing example the user is required to provide user input via user interface 146 to drive the generation of the usage profile. In alternate embodiments, at least some of the information necessary for creating the usage profile may be obtained automatically on behalf of the user and provided to personalized media content recommendation and delivery system 102. For example, user interactions with the various content-providing entities may be monitored (with user permission) by an automated intelligence (running, e.g., on remote control device 120, media content delivery device 118, or some other device via which the user interacts with the content-providing entities 104, 106, and 144) and information necessary for creating the usage profile may be derived from such interactions and passed to personalized media content recommendation and delivery system 102.

As described above, during usage profile creation (or at some other time, depending upon the implementation), a user may assist in the generation of one or more biometric identifiers. A user may assist in the generation of one or more biometric identifiers through, for example, interaction with user interface 146, or such biometric identifiers may be obtained automatically by user identification logic 148, or user identification logic 150. For example, during Mark's creation of his usage profile (or at some other time), Mark may input one or more voice samples, fingerprints and/or facial images. In embodiments, the biometric identifier(s) are stored by system 100 in association with the user, such that they can later be compared to obtained biometric identifiers to identify the user. In embodiments, media content delivery device 118 and/or remote-control device 120 can obtain biometric identifiers. For instance, and as shown in FIG. 1, media content delivery device 118 is configured to store biometric identifiers as part of user identification logic 148 to identify the user based on an obtained biometric identifier. Furthermore, and as shown in FIG. 1, remote-control device 120 is configured to store biometric identifiers as part of user identification logic 150 to identify the user based on an obtained biometric identifier. Still further, and as shown in FIG. 1, personalized media content recommendation and delivery system 102 may store biometric identifiers as part of user identification logic 126 to identify the user based on a biometric identifier received from either media content delivery device 118 or remote-control device 120.

For example, user identification logic 150 of remote control device 120 may recognize Mark's fingerprint and determine that Mark is the user. In another example, user identification logic 126 or user identification logic 148 may recognize Mark's face and determine that Mark is the user. It should be noted that there are numerous examples and there are multiple ways that a user may be recognized via biometric identification or without biometric identification. For instance, any of user identification logic 126, 146, or 150 may simply prompt users to identify themselves.

Database 136 is further configured to maintain a viewing history specific to each usage profile, which includes a viewing history for each applicable content-providing entity, even those that do not support separate user profiles for a single account. For example, FIOS® and DVR do not support multiple user profiles per account. However, if usage profile 138 corresponds to Mark's usage profile, then usage profile 138 would maintain an overall viewing history for Mark based on his user profile specific to Netflix®, his viewing history of FIOS® cable television, and his viewing history of DVR.

Personalized media content recommendation and delivery system 102 is configured to build usage profiles based on the viewing history. Such user's viewing history which may include, by way of example, the last episode of a series watched by the user, where the user left off in a movie, every item of content ever viewed by the user using a service, etc. As shown in FIG. 1, usage profile building logic 130 is configured to receive information to build usage profiles for storing in database 136. For instance, usage profile building logic 130 may interact with one of the content-providing entities via an API, may automatically interact with a website provided by one of the content-providing entities using user login information included in the usage profile, may receive from the media content delivery device an identifier of the item of media content that was watched by the user, or use some combination thereof. Furthermore, usage profile building logic 130 may receive information from media content delivery device 118 that is helpful in tracking the viewing history. For instance, media content delivery device 118 may receive user input from the user that identifies the item of media content that was watched by the user, may identify the item of media content that was watched by the user through ACR, or use a combination thereof. As such, a usage profile is created specific to a user that identifies items of media content watched by the user across multiple content-providing entities (including content-providing entities that do not enable the use of user profiles). For example, following the above example for usage profile 138, usage profile building logic 130 may automatically interact with a website provided by content-providing entity 104 using user login information included in usage profile 138 to obtain Mark's viewing history for Netflix®. Furthermore, media content delivery device 118 may identify the items of media content watched by Mark from content-providing entity 106 and content-providing entity 144 by monitoring user inputs or using ACR to obtain Mark's viewing history for FIOS and DVR, respectively. By using this approach, a viewing history is obtained for content-providing entities that do not enable the use of user profiles since system 100 always knows which user is watching system 100.

Usage profile access logic 132 is configured to determine the associated usage profile based on the identified user. For instance, and as shown in FIG. 1, usage profile access logic 132 is configured to obtain a usage profile, for instance, usage profile 138, usage profile 140, and usage profile 142, as associated with the identified user. For example, if usage profile 138 is associated with user Mark, then when Mark is identified by user identification logic 126, usage profile access logic 132 obtains usage profile 138.

Media content recommendation logic 128 is configured to identify unwatched items of media content based on a usage profile (e.g., usage profile 138) and provide information about the unwatched items of media content to media content delivery device 118 for presentation to the user. Such unwatched items of media content may be identified in various ways. For instance, and in an embodiment, media content recommendation logic 128 is configured to identify the unwatched item of media content by searching a database of items of media content utilizing at least one search term associated with the one or more items of media content identified in the usage profile. In another embodiment, media content recommendation logic 128 is configured to identify the unwatched item of media content by searching a database of media content to obtain a set of unwatched items of media content and filtering or ranking the unwatched items of media content in the set based on information included in the usage profile. The unwatched items of media content may be filtered and/or ranked in various ways, discussed in detail hereinafter. In yet another embodiment, media content recommendation logic 128 is configured to identify the unwatched item of media content by identifying an unwatched item of media content available from a first content-providing entity (e.g., Netflix®) based on an item of media content that is associated with a second content-providing entity (e.g., Hulu®) in the usage profile. In any of the above-described methods, and as noted above, once unwatched items of media content are identified, media content recommendation logic 128 provides information about the unwatched item of media content to media content delivery device 118 for presentation to the user. For example, and as shown in FIG. 1, information about the unwatched items of media content are provided to the user via media content delivery device 118. In an embodiment, the information may include a means for playing back the unwatched item of media content to the user via media content delivery device 118.

Media content recommendation logic 128 is further configured to automatically begin playing an item of media content, provide a means by which the user can play back the item of media content, or merely provide information about the item of media content. The determination may be based on decision logic which includes criteria for making the determination. For example, if the user has previously watched one or more items of media content that have a particular rating (e.g., “G”, “R”, “Mature”) that is the same as or similar to that show, then the decision logic may determine that media content delivery device 118 can automatically begin playing the content via content-viewing device 104. Alternatively, if the user has previously watched shows with only a ‘G’ rating and is trying to watch a show with a ‘R’ rating, the decision logic may determine that the system should not automatically begin playing the content. In an embodiment, one or more criteria used by the decision logic may be adjusted by a user. In another embodiment, the decision logic may determine whether a system should automatically begin playing content based on a user-selected setting of “adult”, “child” or “teenager.” These are examples only, however, and are not intended to be limiting.

Media content delivery logic 134 is configured to identify items of media content in the usage profile (i.e., watched items of media content) and enable playback, or provide the user with a means for playback, of the identified items of media content by media content delivery device 118. Such playback or providing the user with a means for playback may be accomplished in various ways. For instance, media content delivery logic 134 may be configured to identify a point at which the user previously stopped watching the item of media content and resume playback of the item of media content at the point at which the user stopped watching the item of media content. Media content delivery logic 134 may be further configured to resume the playback of the item of media content from the same content-providing entity with which the item of media content is associated in the usage profile. Alternatively, media content delivery logic 134 may be further configured to resume playback of the item of media content from a content-providing entity other than the content-providing entity with which the item of media content is associated in the usage profile. For example, media content delivery logic 134 may resume playback of an item of media content from content-providing entity 104 when the item of media content is associated with content-providing entity 106 in the usage profile.

The aforementioned system can enable some very useful scenarios for a user. For example, the user may talk (e.g., say “watch TV”) to system 100 such that either media content delivery device 118 or remote control device 120 may biometrically identify the user's voice via either user identification logic 148 or user identification logic 150, respectively. Usage profile access logic 132 may then obtain the usage profile associated with the identified user such that media content delivery logic 134 may bring up the last show the user was watching and automatically resume playback. Alternatively, the user may be prompted for user input (e.g., “Do you want to resume playback.”) It should be noted that this is only an example and is not intended to be limiting. For instance, as noted above, the user may be biometrically identified in various ways including obtaining a fingerprint via remote control device 120.

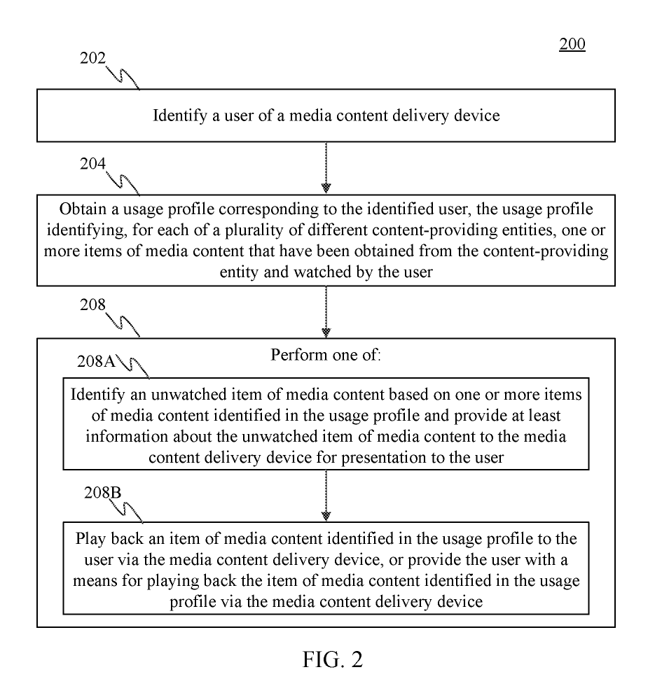

The operation of system 100 will now be further described as follows with respect to FIG. 2. In particular, FIG. 2 depicts a flowchart 200 of a method for providing personalized media content recommendations and/or delivery, in accordance with an embodiment. In an embodiment, system 100 of FIG. 1 may operate according to flowchart 200. Further structural and operational embodiments will be apparent to persons skilled in the relevant art(s) based on the discussion regarding flowchart 200. Flowchart 200 is described as follows.

Flowchart 200 begins with step 202. In step 202, a user of a media content delivery device is identified. For example, and with reference to FIG. 1, a user of media content delivery device 118 may be identified by user identification logic, which may be exist in one or more locations of system 100. For example, and in an embodiment, user identification logic 148 may identify a user of media content delivery device 118. In another embodiment, user identification logic 150 may identify a user of media content delivery device 118. In yet another embodiment, user identification logic 126 may identify a user of media content delivery device 118. In any of the foregoing embodiments, the user may be identified in various ways. For instance, the user may identify themselves in response to a prompt from one of user identification logic 126, 146, or 150. Alternatively, the user identification logic may biometrically identify the user based one or more obtained biometric identifiers. As noted above, the biometric identifiers may include for example, voice samples, fingerprints, or facial images, and may be obtained by media content delivery device 118 and/or remote-control device 120. For example, in accordance with step 202, if Mark picks up remote-control device 120, media content delivery device 118 and/or remote-control device 120 may obtain one or more biometric identifiers such that one or more of user identification logic 126, 148 or 150 may identify Mark.

In step 204, a usage profile corresponding to the identified user is obtained, where the usage profile identifies, for each of a plurality of different content-providing entities, one or more items of media content that have been obtained from the content-providing entity and watched by the user. For example, and with reference to FIG. 1, usage profile access logic 132 may obtain a usage profile corresponding to the identified user. For example, if Mark corresponds to usage profile 138, usage profile access logic 132 will obtain usage profile 138 based on the identification of Mark. Furthermore, with reference to FIG. 1 and as noted above, the usage profile may identify, for each of the applicable content-providing entities 104, 106, and 144, one or more items of media content that have been obtained from the content-providing entity and watched by the user. For example, usage profile 138 may identify that Mark has a Netflix® account “Mark” for content-providing entity 104 Netflix®, that Mark uses content-providing entity 106 FIOS®, and that Mark uses content-providing entity 144 DVR. Furthermore, usage profile 138 may identify all of the items of media content that have been obtained and watched by Mark on each of content-providing entity 104 Netflix®, content-providing entity 106 FIOS®, and content-providing entity 144 DVR. As noted above, and as discussed in detail hereinafter, usage profile 138 is built in various ways and includes personalized viewing histories of all applicable content-providing entities, even those that do not enable the use of a user profile.

In step 206, one of step 206A or step 206B are performed. At step 206A, an unwatched item of media is identified based on one or more items of media content identified in the usage profile and then information about the unwatched item of media content is provided to the media content delivery device for presentation to the user. For example, and with continued reference to FIG. 1, media content recommendation logic 128 may identify an unwatched item of media content based on one or more items of media content identified in usage profile 138 and provide at least information about the unwatched item of media content to media content delivery device 118 for presentation to the user. For example, in accordance with step 206A, media content recommendation logic 128 identifies “Suits: Season 1, Episode 5” as an unwatched item of media content based on usage profile 138 and provides information about “Suits: Season 1, Episode 5” to media content delivery device 118 for presentation to Mark. The information may include, for example, a link to watch it. As noted above, and as discussed in detail hereinafter, media content recommendation logic 128 makes this identification based on items of media content identified in usage profile 138 in a variety of ways.

In step 206B, instead of performing step 206A, an item of media content is identified in the usage profile and is either played back to the user via the media content delivery device or the user is provided with a means for playing back the item of media content via the media content delivery device. For example, and with continued reference to FIG. 1, media content delivery logic 134 may identify an item of media content in usage profile 138. In an embodiment, media content delivery logic 134 may play back the identified item of media content to the user via media content delivery device 118. Alternatively, and in an embodiment, media content delivery logic 134 may provide the user with a means for playing back the item of media content via media content delivery device 118. For example, media content delivery logic 134 identifies “The Office: Season 4, Episode 8” as an item of media content in usage profile 138. Thus, in accordance with step 206B, media content delivery logic 134 plays back “The Office: Season 4, Episode 8” to Mark via media content delivery device 118. Alternatively, and also in accordance with step 206B, media content delivery logic 118 provides Mark with a means for playing back “The Office: Season 4, Episode 8” via media content delivery device 118. As noted above, and as discussed in detail hereinafter, the identified item of media content may be played back in various ways.

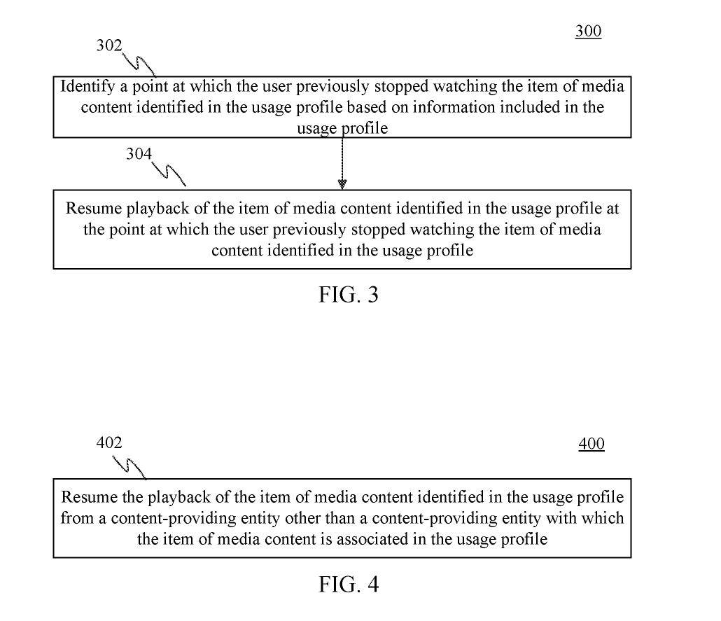

Flowcharts of various methods that may be performed by system 100 or as part of the method of flowchart 200 will now be described. For instance, FIG. 3 depicts a flowchart 300 of a method for playing back an item of media content, in accordance with an embodiment. Flowchart 300 may be performed, for example, as part of performing step 206B according to flowchart 200 as described above. Flowchart 300 may be implemented by media content delivery logic 134 of FIG. 1. Flowchart 300 is described as follows. Other structural and operational embodiments will be apparent to persons skilled in the relevant art(s) based on the following discussion regarding flowchart 300.

Flowchart 300 begins with step 302. In step 302, a point at which the user previously stopped watching the item of media content identified in the usage profile based on information included in the usage profile is identified. For example, and with continued reference to FIG. 1, media content delivery logic 134 may identify a point at which the user previously stopped watching the item of media identified in usage profile 138 based on information included in the usage profile. For example, and in accordance with step 302, media content delivery logic 134 identifies that Mark previously stopped watching “The Office: Season 4, Episode 8” at 20 minutes and 24 seconds.

In step 304, playback of the item of media content identified in the usage profile is resumed at the point at which the user previously stopped watching the item of media content identified in the usage profile. For example, and with continued reference to FIG. 1, media content delivery logic 134 may resume playback of the item of media content identified in the usage profile at the point at which the user previously stopped watching the item of media content identified in usage profile 138. For example, and in accordance with step 304, media content delivery logic 134 plays back “The Office: Season 4, Episode 8” at 20 minutes and 24 seconds. In alternate embodiments, there may be a difference (e.g., a small difference) between the time at which playback stopped and the time at which playback resumed.

As noted above, in some embodiments, a user may stop watching an item of media content on one content-providing entity and then when the user wants to resume playback of the item of media content the content-providing entity is no longer available to user. This could be for many reasons, such as, the user no longer obtains a subscription to a content-providing entity or the content was removed from the content-providing entity. Accordingly, in embodiments, the user may resume playback of the item of media content that is no longer available on the original content-providing entity from another content-providing entity. For instance, FIG. 4 depicts a flowchart 400 of a method for resuming playback of an item of media content, in accordance with an embodiment. Flowchart 400 may be performed, for example, as part of performing step 304 according to flowchart 300 as described above. Flowchart 400 may be implemented by media content delivery logic 134 of FIG. 1. Flowchart 400 is described as follows. Other structural and operational embodiments will be apparent to persons skilled in the relevant art(s) based on the following discussion regarding flowchart 400.

In step 402, playback of an item of media content identified in the usage profile is resumed from a content-providing entity other than a content-providing entity with which the item of media content is associated in the usage profile. For example, and with reference to FIG. 1, media content delivery logic 134 may resume play back an item of media content identified in usage profile 138 from a content-providing entity other than a content-providing entity with which the item of media content is associated in usage profile 138. For instance, if Mark stopped watching “The Office: Season 4, Episode 8” associated in usage profile 138 with content-providing entity 144 DVR at 20 minutes and 24 seconds, and someone else in the household deleted “The Office: Season 4, Episode 8” from content-providing entity 144 DVR, then Mark can no longer resume playback of “The Office: Season 4, Episode 8” from content-providing entity 144. However, if media content delivery logic 134 determines that “The Office: Season 4, Episode 8” is available via content-providing entity 104 Netflix®, then media content delivery logic 134 will resume playback of “The Office: Season 4, Episode 8” from content-providing entity 104 Netflix at 20 minutes and 24 seconds.

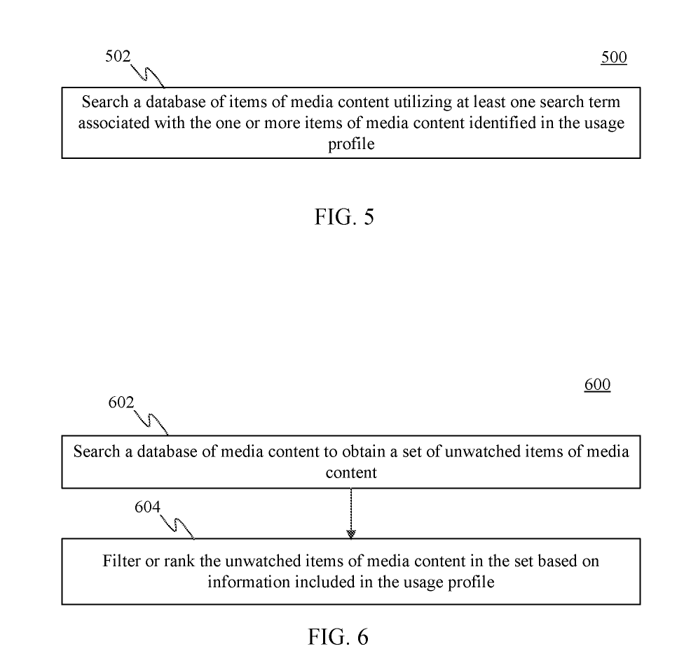

As noted above, not only can system 100 enable the identification of items of media content in the usage profile to enable playback or provide a means to enable playback of the identified items of media content, but system 100 also enables the identification of unwatched items of media content for presentation to the user (e.g., as part of a recommendation or search). System 100 can identify unwatched items of media content in various ways. For instance, FIG. 5 depicts a flowchart 500 of a method for identifying an unwatched item of media content, in accordance with an embodiment. Flowchart 500 may be performed, for example, as part of performing step 208A according to flowchart 200 as described above. Flowchart 500 may be implemented by media content recommendation logic 128 of FIG. 1. Flowchart 500 is described as follows. Other structural and operational embodiments will be apparent to persons skilled in the relevant art(s) based on the following discussion regarding flowchart 500.

In step 502, a database of items of media content is searched utilizing at least one search term associated with the one or more items of media content identified in the usage profile. For example, and with continued reference to FIG. 1, media content recommendation logic 128 may search a database of information about media content items (not shown in FIG. 1) based on at least one search term associated with items of media content identified in usage profile 138. The search term(s) may be obtained in various ways. For instance, in an embodiment, the search term may be derived from metadata associated with items of media content identified in usage profile 138. For example, if usage profile 138 indicates that Mark recently watched an episode of “Suits” and more specifically, “Suits: Season 1, Episode 1”, then media content recommendation logic 128 may search the database for other episodes of suits, and in particular “Suits: Season 1, Episode 2”. As another example, if one or more shows in usage profile 138 have metadata that indicates that they are in the genre “comedy” then media content recommendation logic 128 may conduct a search for unwatched programs that are also in the genre “comedy.”

As noted above, media content recommendation logic 128 identifies unwatched items of media content in various ways. For instance, FIG. 6 depicts a flowchart 600 of another method for identifying an unwatched item of media content, in accordance with an embodiment. Flowchart 600 may be performed, for example, as part of performing step 208A according to flowchart 200 as described above. Flowchart 600 may be implemented by media content recommendation logic 128 of FIG. 1. Flowchart 600 is described as follows. Other structural and operational embodiments will be apparent to persons skilled in the relevant art(s) based on the following discussion regarding flowchart 600.

In step 602, a database of media content is searched to obtain a set of unwatched items of media content. For example, and with continued reference to FIG. 1, media content recommendation logic 128 may search database 136 to obtain a set of unwatched items of media content. For instance, media content recommendation logic 128 searches database 136 to obtain a complete set of unwatched items of media content for Mark. For example, “Suits: Season 1, Episode 5” may be included in the set of unwatched items of media content.

In step 604, the unwatched items of media content in the set are filtered or ranked based on information included in the usage profile. For example, and with continued reference to FIG. 1, media content recommendation logic 128 may filter or rank the unwatched items of media content based on information in usage profile 138. As noted above, the unwatched items of media content may be filtered or ranked in various ways. For instance, in an embodiment, media content recommendation logic 128 may rank or filter the unwatched items of media content based on whether the user possesses a subscription to a content-providing entity associated with each item of unwatched media content as specified by usage profile 138. In another embodiment, media content recommendation logic 128 may rank or filter the unwatched items of media content based on a cost associated with each unwatched item of media content in the set. In yet another embodiment, media content recommendation logic 128 may rank or filter the unwatched items of media content based on a viewing history of the user as specified by the usage profile. In yet another embodiment, media content recommendation logic 128 may rank or filter the unwatched items of media content based on user preferences of the user as specified in usage profile 138. In still another embodiment, media content recommendation logic 128 may rank or filter the unwatched items of media content based on an appropriateness for the user of each unwatched item of media content in the set.

For instance, in an embodiment, since Mark has a subscription to content-providing entity 104 Nefflix®, which provides “Suits: Season 1, Episode 5”, and “Suits: Season 1, Episode 1”—“Suits: Season 1, Episode 4” are identified as watched in usage profile 138, then media content recommendation logic 128 will rank “Suits: Season 1, Episode 5” relatively high up in the set of unwatched items of media content. Furthermore, in an embodiment, if Mark does not have a subscription to HBOGO® (not shown in FIG. 1) and items of media content only provided by content-providing entity HBOGO® are present in the set of unwatched items of media content, media content recommendation logic 138 will filter out these items of media content or rank them below those provided by Netflix® and other content-providing entities to which Mark has access.

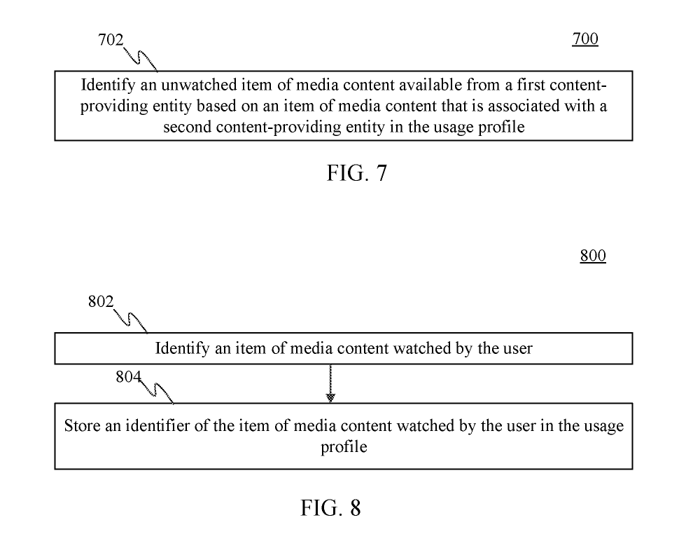

As noted above, system 100 identifies unwatched items of media content in various ways and still further, FIG. 7 depicts a flowchart 700 of another method for identifying an unwatched item of media content, in accordance with an embodiment. Flowchart 700 may be performed, for example, as part of performing step 208A according to flowchart 200 as described above. Flowchart 700 may be implemented by media content recommendation logic 128 of FIG. 1. Flowchart 700 is described as follows. Other structural and operational embodiments will be apparent to persons skilled in the relevant art(s) based on the following discussion regarding flowchart 700.

In step 702, an unwatched item of media content available from a first content-providing entity is identified based on an item of media content that is associated with a second content-providing entity in the usage profile. For example, and with continued reference to FIG. 1, media content recommendation logic 128 may identify an unwatched item of media content available from content-providing entity 104 based on an item of media content that is associated with content-providing entity 144 in usage profile 138. For example, and in accordance with step 702, usage profile 138 identifies “Suits: Season 1, Episode 4” as an item of media content associated with content-providing entity 144. Accordingly, media content recommendation logic 128 identifies “Suits: Season 1, Episode 5” available from content-providing entity 104 based on “Suits: Season 1, Episode 4” associated with content-providing entity 144.

As noted above, usage profiles stored in database 136 may be built in various ways. For instance, FIG. 8 depicts a flowchart 800 of a method for building a usage profile for a user, in accordance with an embodiment. Flowchart 800 may be implemented by usage profile building logic 130 of FIG. 1. Flowchart 800 is described as follows. Other structural and operational embodiments will be apparent to persons skilled in the relevant art(s) based on the following discussion regarding flowchart 800.

Flowchart 800 begins with step 802. In step 802, an item of media content watched by the user is identified. For example, and with reference to FIG. 1, usage profile building logic 130 identifies an item of media content watched by the user. For example, if Mark watches “The Office: Season 4, Episode 8” via content-providing entity 104, usage profile building logic 130 identifies “The Office: Season 4, Episode 8.” The item of media content watched by the user may be identified in various ways, discussed in detail hereinafter.

In step 804, an identifier of the item of media content watched by the user is stored in the usage profile. For example, and with reference to FIG. 1, usage profile building logic 130 stores an identifier of the identified item of media content in a usage profile in database 136. For example, usage profile building logic 130 stores an identifier for “The Office: Season 4, Episode 8” associated with content-providing entity 104 in usage profile 138.

As noted above, the items of media content watched by the user may be identified in various ways. For instance, one of the content-providing entities may be interacted with via an API supported or provided by the content-providing entity. For example, and with continued reference to FIG. 1, usage profile building logic 130 may interact with one of content-providing entities 104 or 106 via an API. For example, if Mark watched “The Office: Season 4, Episode 8” on content-providing entity 104, usage profile building logic 130 may interact via an API with content-providing entity 104 to obtain this viewing history information.

Alternatively, a website provided by one of the content-providing entities may be automatically interacted with using user login information included in the usage profile. For example, and with continued reference to FIG. 1, usage profile building logic 130 may automatically interact with a website provided by content-providing entities 104, 106 using user login information included in usage profile 138. For example, if Mark provided his user login information to content-providing entity 104 and watched “The Office: Season 4, Episode 8,” usage profile building logic 130 may login to the website of content-providing entity 104 to obtain Mark's specific viewing history information.

Still further, an identifier of the item of media content that was watched by the user may be received from the media content delivery device. For example, and with continued reference to FIG. 1, usage profile building logic 130 may receive an identifier of the item of media content that was watched by the user from media content delivery device 118. For example, if Mark watched “The Office: Season 4, Episode 8” via media content delivery device 118, usage profile building logic 130 will receive an identifier of “The Office: Season 4, Episode 8” from media content delivery device 118.

As noted above, the items of media content watched by the user may be identified in various ways. For instance, user input may be received from the user that identifies the item of media content that was watched by the user. For example, and with continued reference to FIG. 1, since the user is using media content delivery device 118 to watch the item of media content, media content delivery device 118 may receive user input via user interface 146 that identifies the item of media content was watched by the user. For example, media content delivery device 118 receives user input that “The Office: Season 4, Episode 8” was watched by usage profile 138.

Alternatively, the item of media content that was watched by the user may be identified through ACR. For example, and with continued reference to FIG. 1, media content delivery device 118 may use ACR to identify that item of media content was watched by the user. For example, media content delivery device 118 uses ACR to identify that “The Office: Season 4, Episode 8” was watched by the user associated with usage profile 138.

### III. Example Computer System Implementation

Various components of above-described personalized searching system may be implemented in hardware, or any combination of hardware with software and/or firmware. For example, various components of the above-described personalized searching system may be implemented as computer program code configured to be executed in one or more processors. In another example, various components of the above-described personalized searching system may be implemented as hardware (e.g., hardware logic/electrical circuitry), or any combination of hardware with software (computer program code configured to be executed in one or more processors or processing devices) and/or firmware.

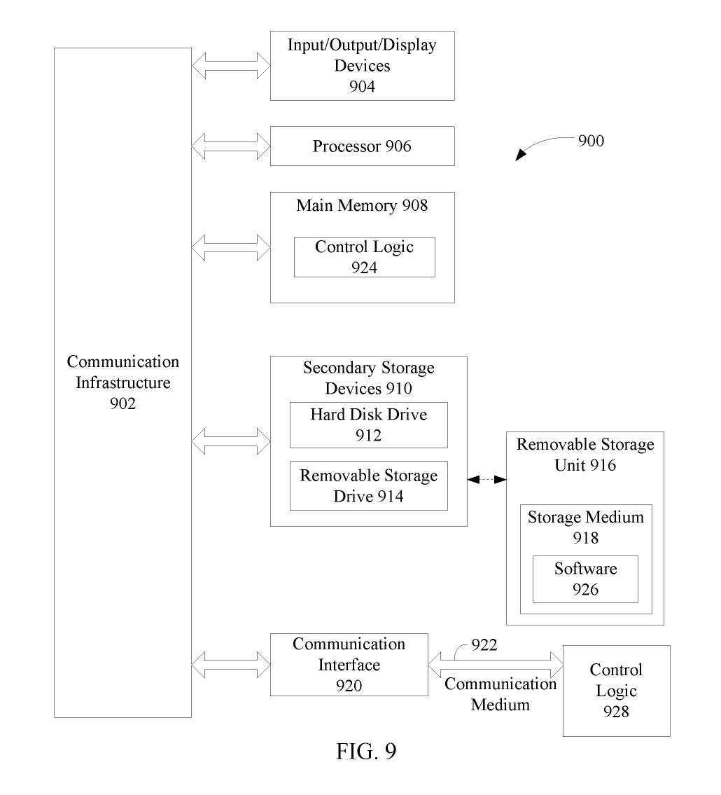

The embodiments described herein, including systems, methods/processes, and/or apparatuses, may be implemented using a processor-based computer system, such as system 900 shown in FIG. 9. For example, various components of the above-described system 100 can each be implemented using one or more systems 900.

System 900 can be any commercially available and well-known computer capable of performing the functions described herein, such as computers available from International Business Machines, Apple, Sun, HP, Dell, Cray, etc. System 900 may be any type of computer, including a desktop computer, a server, etc.

As shown in FIG. 9, system 900 includes one or more processors (also called central processing units, or CPUs), such as a processor 906. Processor 906 may be used to implement certain elements of the above-described system for personalized identification of media content items for recommendation or playback; or any portion or combination thereof, for example, though the scope of the embodiments is not limited in this respect. Processor 906 is connected to a communication infrastructure 920, such as a communication bus. In some embodiments, processor 906 can simultaneously operate multiple computing threads.

System 900 also includes a primary or main memory 908, such as random-access memory (RAM). Main memory 908 has stored therein control logic 924 (computer software), and data.

System 900 also includes one or more secondary storage devices 910. Secondary storage devices 910 may include, for example, a hard disk drive 912 and/or a removable storage device or drive 914, as well as other types of storage devices, such as memory cards and memory sticks. For instance, system 900 may include an industry standard interface, such a universal serial bus (USB) interface for interfacing with devices such as a memory stick. Removable storage drive 914 may represent a floppy disk drive, a magnetic tape drive, a compact disk drive, an optical storage device, tape backup, etc.

Removable storage drive 914 may interact with a removable storage unit 916. Removable storage unit 916 includes a computer useable or readable storage medium 918 having stored therein computer software 926 (control logic) and/or data. Removable storage unit 916 represents a floppy disk, magnetic tape, compact disc (CD), digital versatile disc (DVD), Blu-ray™ disc, optical storage disk, memory stick, memory card, or any other computer data storage device. Removable storage drive 914 reads from and/or writes to removable storage unit 916 in a well-known manner.

System 900 also includes input/output/display devices 904, such as monitors, keyboards, pointing devices, etc.

System 900 further includes a communication or network interface 920. Communication interface 920 enables system 900 to communicate with remote devices. For example, communication interface 920 allows system 900 to communicate over communication networks or mediums 922 (representing a form of a computer useable or readable medium), such as local area networks (LANs), wide area networks (WANs), the Internet, etc. Communication interface 920 may interface with remote sites or networks via wired or wireless connections. Examples of communication interface 922 include but are not limited to a modem, a network interface card (e.g., an Ethernet card), a communication port, a Personal Computer Memory Card International Association (PCMCIA) card, etc.

Control logic 928 may be transmitted to and from system 900 via communication medium 922.

Any apparatus or manufacture comprising a computer useable or readable medium having control logic (software) stored therein is referred to herein as a computer program product or program storage device. This includes, but is not limited to, system 900, main memory 908, secondary storage devices 910, and removable storage unit 916. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable storage media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may store program modules that include computer program logic for implementing the elements of the above-described personalized searching system and/or further embodiments described herein. Embodiments of the invention are directed to computer program products comprising such logic (e.g., in the form of program code, instructions, or software) stored on any computer useable medium. Such program code, when executed in one or more processors, causes a device to operate as described herein.

Note that such computer-readable storage media are distinguished from and non-overlapping with communication media. Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media.

It is noted that while FIG. 9 shows a server/computer, persons skilled in the relevant art(s) would understand that embodiments/features described herein could also be implemented using other well-known processor-based computing devices, including but not limited to, smart phones, tablet computers, netbooks, gaming consoles, personal media players, and the like.

### IV. Additional Example Embodiments

A method if described herein. The method comprises identifying a user of a media content delivery device; obtaining a usage profile corresponding to the identified user, the usage profile identifying, for each of a plurality of different content-providing entities, one or more items of media content that have been obtained from the content-providing entity and watched by the user; and performing one of: identifying an unwatched item of media content based on one or more items of media content identified in the usage profile and providing at least information about the unwatched item of media content to the media content delivery device for presentation to the user; or playing back an item of media content identified in the usage profile to the user via the media content delivery device, or providing the user with a means for playing back the item of media content identified in the usage profile via the media content delivery device.

In one embodiment of the foregoing method, the plurality of different content-providing entities comprises one or more of: a media content recording device; an over-the-top (OTT) content providing service; an online digital media store; a cable television service provider; a satellite television service provider; or an audio content providing service.

In another embodiment of the foregoing method, playing back the item of media content identified in the usage profile comprises: identifying a point at which the user previously stopped watching the item of media content identified in the usage profile based on information included in the usage profile; and resuming playback of the item of media content identified in the usage profile at the point at which the user previously stopped watching the item of media content identified in the usage profile.

In another embodiment of the foregoing method, resuming the playback of the item of media content identified in the usage profile comprises: resuming the playback of the item of media content identified in the usage profile from a content-providing entity other than a content-providing entity with which the item of media content is associated in the usage profile.

In another embodiment of the foregoing method, identifying the unwatched item of media content based on one or more items of media content identified in the usage profile comprises: searching a database of items of media content utilizing at least one search term associated with the one or more items of media content identified in the usage profile.

In another embodiment of the foregoing method, identifying the unwatched item of media content based on one or more items of media content identified in the usage profile comprises: searching a database of media content to obtain a set of unwatched items of media content; filtering or ranking the unwatched items of media content in the set based on information included in the usage profile.

In another embodiment of the foregoing method, filtering or ranking the unwatched items of media content in the set based on at least one of: whether the user possesses a subscription to a content-providing entity associated with each item of unwatched media content as specified by the usage profile; a cost associated with each unwatched item of media content in the set; a viewing history of the user as specified by the usage profile; user preferences of the user as specified in the usage profile; or an appropriateness for the user of each unwatched item of media content in the set.

In another embodiment of the foregoing method, identifying the unwatched item of media content based on the one or more items of media content identified in the usage profile comprises: identifying an unwatched item of media content available from a first content-providing entity based on an item of media content that is associated with a second content-providing entity in the usage profile.

In another embodiment of the foregoing method, identifying the user of the media content delivery device comprises identifying the user of the media content delivery device based on at least one of: a biometric identifier of the user; or user input from the user.

In another embodiment of the foregoing method, the method further comprises building the usage profile for the user by identifying an item of media content watched by the user and storing an identifier of the item of media content watched by the user in the usage profile, wherein identifying the item of media content watched by the user comprises one or more of: interacting with one of the content-providing entities via an application programming interface (API); automatically interacting with a website provided by one of the content-providing entities using user login information included in the usage profile; or receiving from the media content delivery device an identifier of the item of media content that was watched by the user.

In another embodiment of the foregoing method, the user login information includes a user profile identifier.

In another embodiment of the foregoing method, the media content delivery device identifies the item of media content that was watched by the user by performing one of: receiving user input from the user that identifies the item of media content that was watched by the user; identifying the item of media content that was watched by the user through ACR.

A system is described herein. The system comprises one or more memory devices that store program logic; and one or more processors operable to access the memory device(s) and to execute the program logic, the program logic comprises: user identification logic configured to identify a user of a media content delivery device; and usage profile access logic configured to obtain a usage profile corresponding to the identified user, the usage profile identifying, for each of a plurality of different content-providing entities, one or more items of media content that have been obtained from the content-providing entity and watched by the user; and media content recommendation logic configured to identify an unwatched item of media content based on one or more items of media content identified in the usage profile and provide at least information about the unwatched item of media content to the media content delivery device for presentation to the user.

In one embodiment of the foregoing system, the plurality of different content-providing entities comprises one or more of: a media content recording device; an over-the-top (OTT) content providing service; an online digital media store; a cable television service provider; a satellite television service provider; or an audio content providing service.

In another embodiment of the foregoing system, the media content recommendation logic is configured to identify the unwatched item of media content based on one or more items of media content identified in the usage profile by: searching a database of items of media content utilizing at least one search term associated with the one or more items of media content identified in the usage profile.

In another embodiment of the foregoing system, the media content recommendation logic is configured to identify the unwatched item of media content based on one or more items of media content identified in the usage profile by: searching a database of media content to obtain a set of unwatched items of media content; filtering or ranking the unwatched items of media content in the set based on information included in the usage profile.

In another embodiment of the foregoing system, the user identification logic is configured to identify the user of the media content delivery device based on at least one of: a biometric identifier of the user; or user input from the user.

In another embodiment of the foregoing system, the program logic further comprises: usage profile building logic configured to build the usage profile for the user by identifying an item of media content watched by the user and storing an identifier of the item of media content watched by the user in the usage profile, wherein the usage profile building logic is configured to identify the item of media content watched by the user by one or more of: interacting with one of the content-providing entities via an application programming interface (API); automatically interacting with a website provided by one of the content-providing entities using user login information included in the usage profile; or receiving from the media content delivery device an identifier of the item of media content that was watched by the user.

Another system is described herein. The system comprises one or more memory devices that store program logic; and one or more processors operable to access the memory device(s) and to execute the program logic, the program logic comprising: user identification logic configured to identify a user of a media content delivery device; and usage profile access logic configured to obtain a usage profile corresponding to the identified user, the usage profile identifying, for each of a plurality of different content-providing entities, one or more items of media content that have been obtained from the content-providing entity and watched by the user; and media content delivery logic configured to play back an item of media content identified in the usage profile to the user via the media content delivery device, or provide the user with a means for playing back the item of media content identified in the usage profile via the media content delivery device.

In one embodiment of the foregoing system, the media content delivery logic is configured to play back the item of media content identified in the usage profile by: identifying a point at which the user previously stopped watching the item of media content identified in the usage profile based on information included in the usage profile; and resuming playback of the item of media content identified in the usage profile at the point at which the user previously stopped watching the item of media content identified in the usage profile.

### V. Conclusion

Although the foregoing system and techniques are described as assisting users in finding video, audio or audio/video content, a similar approach could be used to assist in finding other types of content including but not limited to video game content, written content, and the like. Particularly, the foregoing system and techniques can be implemented where the users use multiple content-providing services to obtain such content.

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method, comprising:
identifying a user of a media content delivery device;
obtaining a usage profile corresponding to the identified user, the usage profile identifying, for each of a plurality of different content-providing entities, one or more items of media content that have been obtained from the content-providing entity and watched by the user; and
performing one of:
identifying an unwatched item of media content based on one or more items of media content identified in the usage profile and providing at least information about the unwatched item of media content to the media content delivery device for presentation to the user; or
playing back an item of media content identified in the usage profile to the user via the media content delivery device, or providing the user with a means for playing back the item of media content identified in the usage profile via the media content delivery device.

2. The method of claim 1, wherein the plurality of different content-providing entities comprises one or more of:
a media content recording device;
an over-the-top (OTT) content providing service;
an online digital media store;
a cable television service provider;
a satellite television service provider; or
an audio content providing service.

3. The method of claim 1, wherein playing back the item of media content identified in the usage profile comprises:
identifying a point at which the user previously stopped watching the item of media content identified in the usage profile based on information included in the usage profile; and
resuming playback of the item of media content identified in the usage profile at the point at which the user previously stopped watching the item of media content identified in the usage profile.

4. The method of claim 3, wherein resuming the playback of the item of media content identified in the usage profile comprises:
resuming the playback of the item of media content identified in the usage profile from a content-providing entity other than a content-providing entity with which the item of media content is associated in the usage profile.

5. The method of claim 1, wherein identifying the unwatched item of media content based on one or more items of media content identified in the usage profile comprises:
searching a database of items of media content utilizing at least one search term associated with the one or more items of media content identified in the usage profile.

6. The method of claim 1, wherein identifying the unwatched item of media content based on one or more items of media content identified in the usage profile comprises:
searching a database of media content to obtain a set of unwatched items of media content; and
filtering or ranking the unwatched items of media content in the set based on information included in the usage profile.

7. The method of claim 6, wherein the filtering or ranking the unwatched items of media content in the set is based on at least one of:
whether the user possesses a subscription to a content-providing entity associated with each item of unwatched media content as specified by the usage profile;
a cost associated with each unwatched item of media content in the set;
a viewing history of the user as specified by the usage profile;
user preferences of the user as specified in the usage profile; or
an appropriateness for the user of each unwatched item of media content in the set.

8. The method of claim 1, wherein identifying the unwatched item of media content based on the one or more items of media content identified in the usage profile comprises:
identifying an unwatched item of media content available from a first content-providing entity based on an item of media content that is associated with a second content-providing entity in the usage profile.

9. The method of claim 1, wherein identifying the user of the media content delivery device comprises identifying the user of the media content delivery device based on at least one of:
a biometric identifier of the user; or
user input from the user.

10. The method of claim 1, further comprising building the usage profile for the user by identifying an item of media content watched by the user and storing an identifier of the item of media content watched by the user in the usage profile, wherein identifying the item of media content watched by the user comprises one or more of:
interacting with one of the content-providing entities via an application programming interface (API);
automatically interacting with a website provided by one of the content-providing entities using user login information included in the usage profile; or
receiving from the media content delivery device an identifier of the item of media content that was watched by the user.

11. The method of claim 10, wherein the user login information includes a user profile identifier.

12. The method of claim 10, wherein the media content delivery device identifies the item of media content that was watched by the user by performing one of:
receiving user input from the user that identifies the item of media content that was watched by the user; or
identifying the item of media content that was watched by the user through automatic content recognition (ACR).

13. A system, comprising:
one or more memory devices that store program logic; and
one or more processors operable to access the memory device(s) and to execute the program logic, the program logic comprising:
user identification logic configured to identify a user of a media content delivery device; and
usage profile access logic configured to obtain a usage profile corresponding to the identified user, the usage profile identifying, for each of a plurality of different content-providing entities, one or more items of media content that have been obtained from the content-providing entity and watched by the user; and
media content recommendation logic configured to identify an unwatched item of media content based on one or more items of media content identified in the usage profile and provide at least information about the unwatched item of media content to the media content delivery device for presentation to the user.

14. The system of claim 13, wherein the plurality of different content-providing entities comprises one or more of:
a media content recording device;
an over-the-top (OTT) content providing service;
an online digital media store;
a cable television service provider;
a satellite television service provider; or
an audio content providing service.

15. The system of claim 13, wherein the media content recommendation logic is configured to identify the unwatched item of media content based on one or more items of media content identified in the usage profile by:
searching a database of items of media content utilizing at least one search term associated with the one or more items of media content identified in the usage profile.

16. The system of claim 13, wherein the media content recommendation logic is configured to identify the unwatched item of media content based on one or more items of media content identified in the usage profile by:
searching a database of media content to obtain a set of unwatched items of media content; or
filtering or ranking the unwatched items of media content in the set based on information included in the usage profile.

17. The system of claim 13, wherein the user identification logic is configured to identify the user of the media content delivery device based on at least one of:
a biometric identifier of the user; or
user input from the user.

18. The system of claim 13, wherein the program logic further comprises:
usage profile building logic configured to build the usage profile for the user by identifying an item of media content watched by the user and storing an identifier of the item of media content watched by the user in the usage profile, wherein the usage profile building logic is configured to identify the item of media content watched by the user by one or more of:
interacting with one of the content-providing entities via an application programming interface (API);
automatically interacting with a website provided by one of the content-providing entities using user login information included in the usage profile; or
receiving from the media content delivery device an identifier of the item of media content that was watched by the user.

19. A system, comprising:
one or more memory devices that store program logic; and
one or more processors operable to access the memory device(s) and to execute the program logic, the program logic comprising:
user identification logic configured to identify a user of a media content delivery device; and
usage profile access logic configured to obtain a usage profile corresponding to the identified user, the usage profile identifying, for each of a plurality of different content-providing entities, one or more items of media content that have been obtained from the content-providing entity and watched by the user; and
media content delivery logic configured to play back an item of media content identified in the usage profile to the user via the media content delivery device, or provide the user with a means for playing back the item of media content identified in the usage profile via the media content delivery device.

20. The system of claim 19, wherein the media content delivery logic is configured to play back the item of media content identified in the usage profile by:
identifying a point at which the user previously stopped watching the item of media content identified in the usage profile based on information included in the usage profile; and
resuming playback of the item of media content identified in the usage profile at the point at which the user previously stopped watching the item of media content identified in the usage profile.
